(19) United States
(12) Patent Application Publication
(10) Pub. No.: US 2006/0005717 A1
(43) Pub. Date: Jan. 12, 2006

(54) Embossed three-dimensional nonwoven fabrics and the products thereof

(75) Inventors: Patrick Barge, Brentwood, TN (US); Nick Carter, Hutchinson, KS (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 11/012,790

(22) Filed: Dec. 15, 2004

Related U.S. Application Data
(60) Provisional application No. 60/529,675, filed on Dec. 15, 2003.

(51) Int. Cl. B31F 1/07

(52) U.S. Cl. 101/27; 101/32

(57) ABSTRACT

The present invention is directed to an embossed, three-dimensionally imaged nonwoven fabric, and more specifically, to an embossed, three-dimensionally imaged nonwoven fabric particularly suited for wipe applications. Further, the subsequent action of the entangling jets, which impart the three-dimensional images, affects the rigidity of the embossed images so as to provide a softer, more drapeable wipe.

### TECHNICAL FIELD

The present invention generally relates to an embossed, three-dimensionally imaged nonwoven fabric, and more specifically, to an embossed, three-dimensionally imaged nonwoven fabric particularly suited for various wipe applications.

### BACKGROUND OF THE INVENTION

Nonwoven fabrics are suitable for use in a wide variety of applications where the efficiency with which the fabrics can be manufactured provides a significant economic advantage for nonwoven fabrics versus traditional textiles. The general use of nonwoven fabrics as limited use wipes is well known in the art. Various end-use articles are commercially available which utilize a combination of topical, performance enhancing additives and/or multi-layered laminate constructions. Enhanced versions of wipes used in cleaning applications further incorporate an optional cleaning fluid, including but not limited to, soaps, lotions, disinfectants, polishing solutions, and glass cleaners.

More recently, so as to improve the aesthetic, as well as performance quality of the nonwoven wipe, hydroentanglement techniques have been developed which impart images or patterns to the entangled fabric by effecting hydroentanglement on three-dimensional image transfer devices. Such three-dimensional image transfer devices are disclosed in U.S. Pat. No. 5,098,764, which is hereby incorporated by reference; with the use of such image transfer devices being desirable for providing a fabric with enhanced physical properties as well as an aesthetically pleasing appearance.

In addition to imparting a three-dimensional image to aesthetically enhance a fabric, thermal embossing an image into a fabric also provides added visual appeal. In a calendar-bonding process the nonwoven web is fed into the nip of two counter-rotating calendar rollers, at least one of which is heated and comprises raised areas that compress and melt-bond adjacent fibers of the nonwoven web in the compressed regions. While being a good method of embossing, such melt-bonding and re-solidifying of the fibers tends to stiffen the web, making it unsatisfactory for use as a wipe. U.S. Pat. No. 6,361,784 to Brennan, et al., hereby incorporated by reference, claims limitations on the size of the calendar embossed images, as well as the spacing of the images within the fabric, in relation to the length of the staple fiber being utilized. The strategic placement of the images and the size of the images in the aforementioned prior art allows for acceptable drapeability of the fabric.

An unmet need exists for a soft, drapeable wipe that comprises aesthetic appeal by the incorporation of embossed images without size and spacing limitations. The present invention contemplates a nonwoven fabric that exhibits one or more embossed images, as well as one or more three-dimensional images, wherein the thermally embossed images are affected by the subsequent entangling process of incorporating the three-dimensional images so as to soften the wipe and provide the desired drapeability.

It is further an objective of the present invention to provide a method of making a soft, drapeable nonwoven fabric suitable for end-use wipe applications, whereby the article comprises at least a first thermally embossed image and a first three-dimensional image, said first thermally embossed image exhibiting an aesthetic appeal and said first three-dimensional image imparting a performance attribute, aesthetic appeal, or both. The nonwoven fabric of the present invention is suitable for numerous home, medical, and hygiene wipe applications.

### SUMMARY OF THE INVENTION

The present invention is directed to an embossed, three-dimensionally imaged nonwoven fabric, and more specifically, to an embossed, three-dimensionally imaged nonwoven fabric particularly suited for wipe applications. Further, the subsequent action of the entangling jets, which impart the three-dimensional images, affects the rigidity of the embossed images so as to provide a softer, more drapeable wipe. Further still, the present invention contemplates a fabric comprised of a plurality of embossed images and three-dimensional images which can provide the fabric with various physical and/or aesthetic performances, for example; the first embossed image may serve as an aesthetic enhancement and the first three-dimensional image may provide a physical performance, such as exfoliation or particulate entrainment, or provide further aesthetic appeal to the fabric. It is also within the purview of the present invention that the first embossed image and the first three-dimensional image may both provide aesthetic enhancement to the fabric.

In accordance with the present invention, a method of making a nonwoven fabric includes the steps of providing a precursor web comprising a fibrous matrix. While use of staple length fibers is typical, the fibrous matrix may comprise substantially continuous filaments. In a particularly preferred form, the fibrous matrix comprises staple length fibers, which are carded and cross-lapped to form a precursor web. In one embodiment, the nonwoven fabric is a composite or laminate structure wherein the precursor web is comprised of one or more additional nonwoven layers, such as a support layer, a woven layer, such as a knit, or a scrim.

In a particular embodiment envisioned by the present invention, the one or more three-dimensional images of the resultant nonwoven fabric are adjoined to the background image of the fibrous substrate through fibrous bundles, referred to as fibrous transitions regions as specifically described in U.S. Pat. No. 5,674,591 to James et al., which is hereby incorporated by reference.

In a third embodiment, the nonwoven fabric of the invention comprises a first thermally embossed image and a first three-dimensional image, wherein one or more of the three-dimensional images comprises a repeating pattern of one or more apertures. The apertures may extend entirely or partially through the substrate, and/or may be distributed in an organized fashion or randomly scattered through out the resultant nonwoven fabric.

Subsequent to the fabric formation, the thermally embossed and three-dimensionally imaged nonwoven fabric can be treated with one or more performance or aesthetic modifying composition to further alter the fabric structure or to meet end-use article requirements. A polymeric binder composition can be selected to enhance durability characteristics of the fabric, while maintaining the desired softness and drapeability of the three-dimensionally imaged fabric. A surfactant can be applied so as to impart hydrophilic properties.

In a forth embodiment, the nonwoven fabric includes the use of various aqueous and non-aqueous compositions. The fabric embodying the principles of the present invention is especially soft and drapeable making it particularly suitable for various end-use wipe applications. The nonwoven fabric may be used in home care applications, wherein the end use article may be a dry or wet hand held sheet, such as a wipe, a mitt formation, or a cleaning implement capable of retaining the wipe. The nonwoven fabric is suitable for cleaning a plurality of household surfaces including, but not limited to, kitchen and bathroom counter tops, sinks, bathtubs, showers, appliances, and fixtures. The nonwoven fabric is also suitable for personal cleaning or cleansing articles. Non-limiting examples of such applications include dry or wet facial wipes, body wipes, and baby wipes. Additional industrial and medical end-use applications may benefit from the nonwoven fabric of the present invention as well.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a durable nonwoven fabric, embodying the principles of the present invention.

### DETAILED DESCRIPTION

While the present invention is susceptible of embodiment in various forms, there is shown in the drawings, and will hereinafter be described, a presently preferred embodiment of the invention, with the understanding that the present disclosure is to be considered as an exemplification of the invention, and is not intended to limit the invention to the specific embodiment illustrated.

The present invention is directed to an embossed, three-dimensionally imaged nonwoven fabric, and more specifically, to an embossed, three-dimensionally imaged nonwoven fabric particularly suited for wipe applications. According to the present invention, the first embossed image may serve as an aesthetic enhancement and the first three-dimensional image may provide a physical performance, such as exfoliation or particulate entrainment, or provide further aesthetic appeal to the fabric

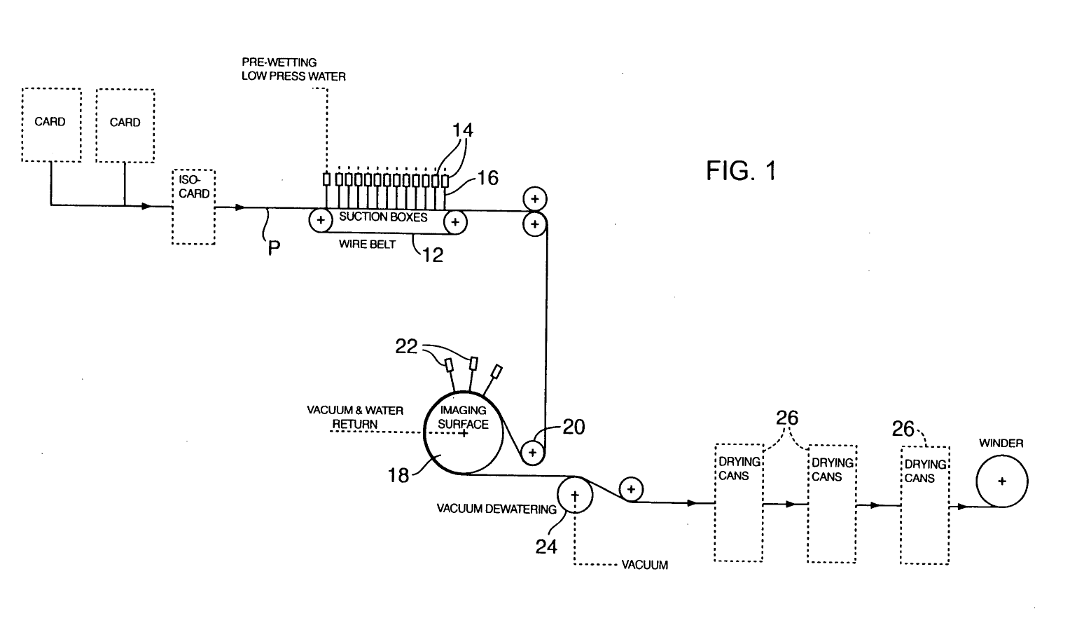

With reference to FIG. 1, therein is illustrated an apparatus for practicing the present method for forming a nonwoven fabric. The fabric is formed from a fibrous matrix, which typically comprises staple length fibers, but may comprise substantially continuous filaments. The fibrous matrix is preferably carded and cross-lapped to form a fibrous batt, designated F. In a current embodiment, the fibrous batt comprises 100% cross-lap fibers, that is, all of the fibers of the web have been formed by cross-lapping a carded web so that the fibers are oriented at an angle relative to the machine direction of the resultant web. U.S. Pat. No. 5,475,903, hereby incorporated by reference, illustrates a web drafting apparatus.

The apparatus of the present invention includes a foraminous forming surface in the form of a flat bed entangler 12 upon which the precursor web P is positioned for pre-entangling. Precursor web P is then sequentially passed under entangling manifolds 14, whereby the precursor web is subjected to high-pressure water jets 16. This process is well known to those skilled in the art and is generally taught by U.S. Pat. No. 3,485,706, to Evans, hereby incorporated by reference.

The entangling apparatus of FIG. 1 further includes an imaging and patterning drum 18 comprising a three-dimensional image transfer device for effecting imaging and patterning of the now-entangled precursor web. The three-dimensional image transfer device of the present invention comprises at least two dissimilar images embedded within the imaging movable surface. After pre-entangling, the precursor web is trained over a guide roller 20 and directed to the image transfer device 18, where a plurality of three-dimensional images are imparted into the fabric on the foraminous forming surface of the device. The web of fibers is juxtaposed to the image transfer device 18, and high pressure water from manifolds 22 is directed against the outwardly facing surface from jet spaced radially outwardly of the image transfer device 18. The image transfer device 18, and manifolds 22, may be formed and operated in accordance with the teachings of commonly assigned U.S. Pat. No. 5,098,764, No. 5,244,711, No. 5,822,823, and No. 5,827,597, the disclosures of which are hereby incorporated by reference. The entangled fabric can be vacuum dewatered at 24, and dried at an elevated temperature on drying cans 26.

Either prior to entanglement or subsequent to entanglement, preferably prior to entanglement, the nonwoven fabric is thermally embossed so as to impart an image. Imparting a three-dimensional image into the fabric after the fabric has been thermally embossed enhances the drapeability of the fabric, wherein the hydraulic pressure of the three-dimensional imaging process tends to break the thermal bonds of the embossed image, which typically lend to the rigidity of the fabric.

Thermal embossing techniques include calendar-embossing and ultrasonic embossing. In a calendar-embossing process the nonwoven fabric is fed into the nip of two counter-rotating calendar rollers, at least one of which is heated and comprises raised areas that compress and melt-bond adjacent fibers of the fabric in the compressed regions. Such bonding techniques are described in U.S. Pat. No. 3,478,141, to Dempsey, et al. and U.S. Pat. No. 6,554,963, to Botelho, et al., both of which are hereby incorporated by reference. Ultrasonic embossing involves the use of a patterned roll anvil, or the equivalent, and a horn of an ultrasonic welding machine. U.S. Pat. No. 4,394,208 and No. 4,311,540, hereby incorporated by reference are representative of the ultrasonic bonding technique.

The nonwoven fabric of the present invention may be a composite, laminate, single layer or multiple layers in order to incorporate support, such as a scrim and/or absorbent mechanisms into the thermally embossed and three-dimensionally imaged fabric. A plurality of embossed and three-dimensional images can provide the fabric with various attributes, for example, the first embossed image may serve as an aesthetic enhancement and the first three-dimensional image may provide a performance attribute or the embossed and three-dimensional images may both provide for aesthetic enhancement of the over all resultant nonwoven fabric. Further, the nonwoven fabric exhibits adequate drapeability and softness, both advantageous to personal care wipe applications.

Optionally, the three-dimensional images of the resultant nonwoven fabric can be adjoined to the background of the fibrous substrate or adjoined to a second underlying three-dimensional image through fibrous bundles, referred to as fibrous transitions regions as previously mentioned.

It is within the purview of present invention that the nonwoven fabric comprises more than one embossed and/or three-dimensional images. Further, one or more three-dimensional images may comprise a repeating pattern of one or more apertures. The apertures may extend entirely or partially through the substrate, and/or may be distributed in an organized fashion or randomly scattered through out the resultant nonwoven fabric.

The nonwoven fabric can be further modified aesthetically through subsequent dyeing, and printing, or by using colored fibers during the manufacturing step, to achieve the effects of the desired nonwoven fabric.

Manufacture of a nonwoven fabric comprised of a plurality of thermally embossed and three-dimensional images embodying the principles of the present invention is initiated by providing the fibrous matrix, which can include the use of staple length fibers, continuous filaments, and the blends of fibers and/or filaments having the same or different composition. Fibers and/or filaments are selected from natural or synthetic composition, of homogeneous or mixed fiber length. Suitable natural fibers include, but are not limited to, cotton, reconstituted cotton, wood pulp and viscose rayon. Synthetic fibers, which may be blended in whole or part, include thermoplastic and thermoset polymers. Thermoplastic polymers suitable for blending with dispersant thermoplastic resins include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 10 inches, the range of 1 to 3 inches being preferred and the fiber denier selected in the range of 1 to 22, the range of 2.0 to 8 denier being preferred for general applications. The profile of the fiber and/or filament is not a limitation to the applicability of the present invention.

In accordance with the present invention the nonwoven fabric may be impregnated or coated with an aqueous or non-aqueous composition. Suitable compositions that may be utilized in accordance with the present invention can comprise a wide range of optional ingredients. The CTFA International Cosmetic ingredient Dictionary, Sixth Edition, 1995, which is incorporated by reference herein in its entirety, describes a wide variety of non-limiting cosmetic and pharmaceutical ingredients commonly used in the skin care industry, which are suitable for use in the compositions of the present invention. Non-limiting examples of functional classes of ingredients are described at page 537 of this reference. Examples of these functional classes include: abrasives, anti-acne agents, anti-caking agents, antioxidants, binders, biological additives, bulking agents, chelating agents, chemical additives, natural additives, colorants, cosmetic astringents, cosmetic biocides, degreasers, denaturants, drug astringents, emulsifiers, external analgesics, film formers, fragrance components, humectants, opacifying agents, plasticizers, preservatives, propellants, reducing agents, skin bleaching agents, skin-conditioning agents (emollient, humectants, miscellaneous, and occlusive), skin protectants, solvents, foam boosters, hydrotropes, solubilizing agents, suspending agents (non-surfactant), sunscreen agents, ultraviolet light absorbers, and viscosity increasing agents (aqueous and non-aqueous). Examples of other functional classes of materials useful herein that are well known to one of ordinary skill in the art include solubilizing agents, sequestrants, and keratolytics, and the like. Suitable methods for the application of various aqueous and non-aqueous compositions comprise aqueous/alcoholic impregnates, including flood coating, spray coating or metered dosing. Further, more specialized techniques, such as Meyer Rod, floating knife or doctor blade, which are typically used to impregnate cleansing solutions into absorbent sheets, may also be used. The compositions preferably comprise from about 50% to about 500%, preferably from about 200% to about 400% by weight of the nonwoven cleaning article.

The aforementioned classes of ingredients are incorporated in a safe and effective amount. The term “safe and effective amount” as used herein, means an amount of an active ingredient high enough to modify the condition to be treated or to deliver the desired skin benefit, but low enough to avoid serious side effects, at a reasonable benefit to risk ratio within the scope of sound medical judgment.

In addition to home care and personal care wipe end uses, the nonwoven fabric may be used in industrial and medical applications. For instance, the article may be useful in paint preparation and cleaning outdoor surfaces, such as lawn furniture, grills, and outdoor equipment, wherein the low linting attributes of the laminate may be desirable. Aqueous or non-aqueous functional industrial solvents include, oils, such as plant oils, animal oils, terpenoids, silicon oils, mineral oils, white mineral oils, paraffinic solvents, polybutylenes, polyisobutylenes, polyalphaolefins, and mixtures thereof, toluenes, sequestering agents, corrosion inhibitors, abrasives, petroleum distillates, and the combinations thereof.

A medical wipe may incorporate an antimicrobial composition, including, but not limited to iodines, alcohols, such as such as ethanol or propanol, biocides, abrasives, metallic materials, such as metal oxide, metal salt, metal complex, metal alloy or mixtures thereof, bacteriostatic complexes, bactericidal complexes, and the combinations thereof.

The wipe of the present invention is particularly suitable for dispensing from a tub of stacked, folded wipes, or for dispensing as “pop-up” wipes, in which the cleaning article is stored in the tub as a perforated continuous roll, wherein upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The wipe may be packaged in various convenient forms, whereby the method of packaging is not meant to be a limitation of the present invention.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A method of making a three-dimensionally imaged, thermally embossed nonwoven fabric comprising the steps of:
a. providing a precursor web;
b. providing a three-dimensional image transfer device;
c. thermally embossing said precursor web so as to impart at least one embossed image;
d. advancing said embossed precursor web onto said three-dimensional image transfer device so as to impart at least one three-dimensional image, wherein said thermally embossed image provides said nonwoven fabric with an aesthetic enhancement and said three-dimensional image provides said fabric with at least one of: a performance enhancement, and an aesthetic enhancement.

2. A thermally embossed, three-dimensional nonwoven fabric comprising at least a first thermally embossed image and at least a first three-dimensional image wherein said first embossed image provides an aesthetic enhancement and said first three-dimensional image provides at least one of: a physical performance, and an aesthetic enhancement.

3. A method of making a nonwoven wipe comprising the steps of:
a. providing a nonwoven fabric comprised of least a first thermally embossed image and at least a first three-dimensional image wherein said first embossed image provides an aesthetic enhancement and said first three-dimensional image provides at least one of: a physical performance, and an aesthetic enhancement; and
b. a cleansing composition comprising an effective amount of a cleansing surfactant, said aqueous liquid cleansing composition being coated onto or impregnated into said substrate to the extent of from 50% to 500% by weight of the substrate.

4. A nonwoven wipe comprising at least a first thermally embossed image and at least a first three-dimensional image wherein said first embossed image provides an aesthetic enhancement and said first three-dimensional image provides at least one of: a physical performance, and an aesthetic enhancement.
